(19) United States
(12) Patent Application Publication
(10) Pub. No.: US 2016/0134854 A1
(43) Pub. Date: May 12, 2016

(54) AUTOMATED WHITE BALANCING IN DIGITAL PHOTOGRAPHY

(71) Applicant: Gary Stephen SHUSTER, Fresno, CA (US)

(72) Inventor: Gary Stephen SHUSTER, Fresno, CA (US)

(21) Appl. No.: 14/997,418

(22) Filed: Jan. 15, 2016

Related U.S. Application Data
(63) Continuation of application No. 12/751,357, filed on Mar. 31, 2010, now abandoned.
(60) Provisional application No. 61/165,099, filed on Mar. 31, 2009.

(51) Int. Cl. H04N 9/73; G06K 19/06; H04N 17/00

(52) U.S. Cl. CPC H04N 9/735; H04N 17/002; G06K 19/06018

(57) ABSTRACT

A method for improving white balance measurement for digital cameras or the like uses color reference articles for placement within a scene coordinated with a digital camera capable of automatically recognizing the color reference supplied by the article. The reference articles comprise a signaling device (such as an RFID chip, an LED that emits in a specified and unique spectral area, or a watermark) that allows the digital camera to pinpoint the location of the reference article, its color value, size, and other information needed to use the reference article for color balancing. The digital camera receives the signal from the reference article and uses it for white balancing.

### CROSS-REFERENCE TO RELATED APPLICATION

This application is a continuation of U.S. patent application Ser. No. 12/751,357; which claims the benefit of U.S. Provisional Patent Application No. 61/165,099, filed Mar. 31, 2009, which is specifically incorporated by reference herein in its entirety.

### BACKGROUND

1. Field

The present disclosure relates to automated white balancing in digital photography.

2. Description of Related Art

Photography in different lighting conditions can produce unpredictable or undesired results, particularly for the amateur photographer. For example, photographs may turn out with a yellow/orange cast in incandescent (tungsten) lighting and bluish in fluorescent lighting. This effect results from the different color temperatures of various light sources. A low color temperature shifts light toward the red; a high color temperature shifts light toward the blue. In film or digital photography, skilled photographers may compensate for the color shift by using an orange or blue filter. In digital photography, corrective color shifting can be done electronically by processing the signal from the image sensor. However, digital cameras must be programmed to color shift in the proper direction and by a proper amount.

Modern digital cameras therefore often allow for manual white balancing in various lighting conditions. White balancing may sometimes be also referred to as color balancing, neutral balancing, or gray balancing. Manual white balance may be accomplished with such cameras by pointing the camera at a white or gray color reference card angled so that it is reflecting the light to be used for the photograph as a neutral reference and the camera's field of view is filled completely with an image of the neutral reference. Then, the user may instruct the camera to perform a white balance calculation by selecting a White Balance button or menu option off of the camera controls. Subsequent pictures by the camera will use the white balance correction calculated for the reference card and lighting applied, until the white balance is canceled or reset.

Manual color correction, however, may not be so easily accomplished in many real life situations. For one thing, the photographer must remember to bring the color reference card and how to navigate the camera control menus to perform a white balance. For another, the photographer must properly place the reference card so it is illuminated by the same lighting as will be used for the photograph. Knowing the difficulties of obtaining proper manual white balance in the field, many photographers save images in RAW mode for later correction. However, RAW mode requires substantially more memory than saving compressed images, and still requires post processing which many users may find inconvenient, impractical or too expensive. It is desirable that white-balancing be done automatically, within the camera, enabling white balanced photographs to be directly printed or emailed without the need for post-processing.

Because of the shortcomings of manual white balance, many digital cameras also allow the user to select one or more various preset color corrections for different lighting situations. The camera may label white balance settings with helpful designations such as, for example, Tungsten, Fluorescent, Cloudy, Sunny, and so forth. Such preset corrections may be helpful to users that take the time to understand and use them. However, preset corrections cannot accurately correct for actual lighting conditions, unlike manual color correction. Instead, the preset corrections rely on guesswork by the photographer and camera manufacturer to achieve fairly accurate results. Results may be somewhat haphazard and unsatisfactory. In short, manual and automatic color correction as it exists today is far from “point and shoot” easy for the average digital camera user.

Therefore, it would be desirable to provide a method and system for automated white balancing in digital photography, that overcomes the limitations of the prior art.

### SUMMARY

The solution is to include digitally recognizable color reference article comprising a means for automatic color reference recognition by a digital camera. Each color reference includes a visible external surface having a defined color value as a color reference, and a means for wirelessly transmitting color reference information to a digital camera. The color reference information may include the position, size and optionally the orientation of the color reference article, and the color value; or the position, size and optionally the orientation of one or more visible surfaces of the color reference article in the photo frame and an identifier by which the digital camera can locate the size and color value of the reference article in a database. The wireless transmitting means may comprise an RFID device. In the alternative, or in addition, the wireless transmitting means may comprise an LED device transmitting an infrared, ultraviolet, or visible light signal. In the alternative, the wireless transmitting means may comprise an optical code or watermark placed in, or adjacent to the digital camera.

Each digitally recognizable color reference article may comprise an object often found in photographic scenes, such as, for example, an article of clothing or part of an article of clothing, a hat, a brooch or pin, a photographic backdrop, a stuffed animal or other photographic prop, a wall, a table, artwork or reference card. For example, a shirt may be provided with a pattern of blue and white stripes. One of the blue stripes transmits the signal “Pantone Blue #1” and a white stripe transmits the signal “Pantone White #7”. The digital camera receives and processes the transmitted signals to define the location and extent of the reference article in a photograph. From this, the digital camera may determine the color correction needed using methods of color correction known in the art where one or more color references are known, apply the correction to the image data, and save the corrected image in a camera memory for later viewing and printing. In the alternative, or in addition, the camera may save the color reference information or the recommended color correction as metadata with the uncorrected RAW image data for later use in post-processing.

The means for wireless transmitting may, in the alternative, comprise an optical pattern, such as a bar code or other optical code, or a watermark. In this instance, the digital camera may be programmed to process captured images to detect any recognizable optical code in the image frame. If a code is recognized, the digital camera may process the code to obtain the color reference information, and then process the image using the color reference information to obtain a color correction value. The camera may process the image using the color correction value to obtain and save a corrected image for viewing or printing, or save the recommended color correction as metadata with the image data for later processing.

If an RFID device or other electronic device is used for signaling color reference information to the digital camera, the device may incorporate functionality for recalibrating the color value. Color recalibration may be particularly useful for articles subject to fading, such as clothing. The article may be inspected using a color measurement device, and the RFID chip or other signaling device reprogrammed to transmit the measured color of the clothing or other reference article.

A more complete understanding of automated white balancing in digital photography will be afforded to those skilled in the art, as well as a realization of additional advantages and objects thereof, by a consideration of the following detailed description. Reference will be made to the appended sheets of drawings which will first be described briefly.

### BRIEF DESCRIPTION OF THE DRAWINGS

FIG. 1 shows a digital camera and scene with a signaling device for automated white balancing.

FIG. 2 is a block diagram showing components of a system for automated white balancing in digital photography.

FIG. 3 shows a scene with a signaling device located in an article of clothing and defining a test region.

FIG. 4 shows a cross section of an article of clothing and signaling device.

FIG. 5 is a flow chart showing steps of an algorithm for automated white balancing in digital photography.

### DETAILED DESCRIPTION

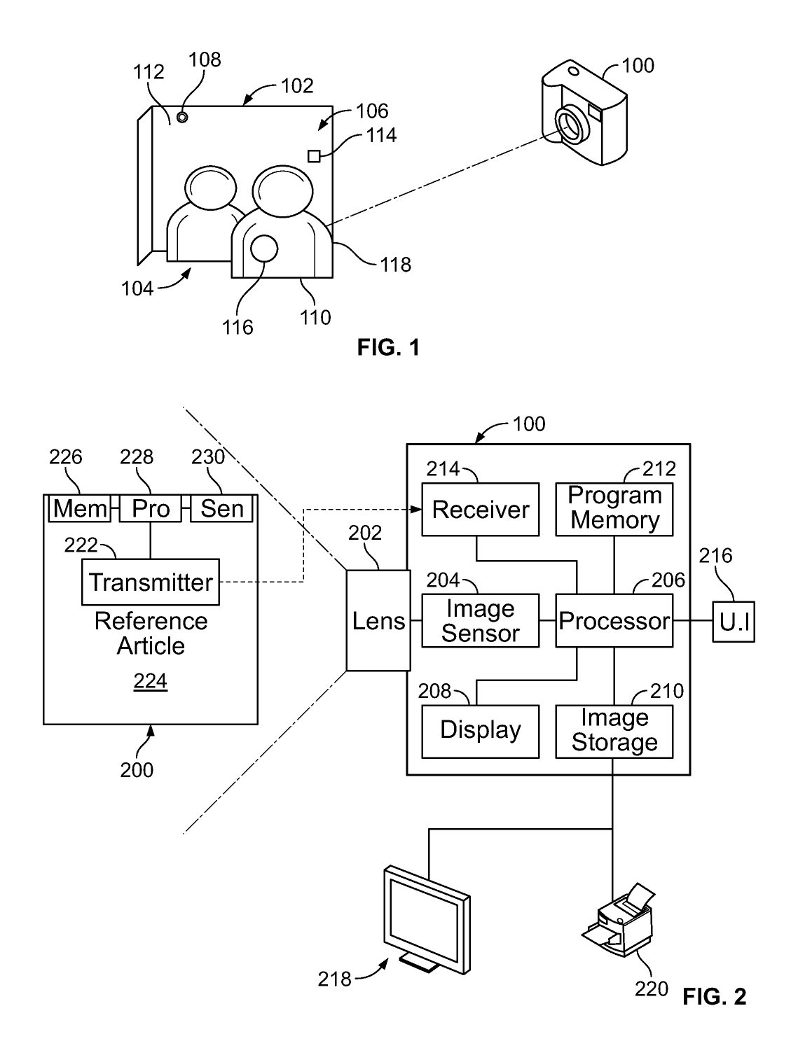

While the present technology may be used in a variety of consumer, commercial, and industrial applications, the present disclosure concerns applications in consumer products such as portable digital cameras. The technology described herein is not limited to such examples, however. FIG. 1 shows a portable digital camera 100 positioned to photograph a scene 102. The scene 102 may comprise a foreground 104, which in this example includes two human subjects, and a background 106. A wireless transmitter 108, 110 may be positioned on or in any object in the scene 102. It is not necessary for the transmitter to be positioned in the scene, however. The transmitter may be positioned anywhere within range of the digital camera 100 when the digital camera takes a picture of the scene 102, or while the digital camera prepares to take a picture of the scene. Two transmitters are shown, but any non-zero integral number of transmitters may be used. Venues in which photographs are frequently taken by different people, or example tourist sites, theme parks or banquet halls, may install fixed reference articles in typical backgrounds to serve visitors or members.

Either transmitter 108, 110 may be operatively coupled with a memory storing information relative to one or more color reference articles 112, 114, 116, 118, sometimes referred to as color targets. For example, a reference article may comprise a wall surface 112, a surface of an object 114 fixed to a wall, a surface of an object 116 fixed to an article of clothing, or an article of clothing 118. The information should include color value information, including but not limited to a predetermined code or name indicating a specific color value, or a recognizable identifier for a database record containing a color value. A color value may comprise one or more numeric values indicating a color, for example, RGB values for the reference article when photographed under controlled lighting conditions, known position and orientation, and camera settings, using a scale used by or translatable by the digital camera 100. Such reference values may be stored by digital camera 100 or incorporated in programmed logic used by camera 100. In some embodiments, the camera may use as few as one reference value incorporated in its programming logic while the transmitter may simply indicate that a reference article corresponding to the pre-programmed reference value is present in the field of view.

To further illustrate operation of the reference values, consider an example wherein a color target is photographed under controlled lighting conditions using a specific camera model during development of the camera model. These test photos of the color target may be taken at different relative camera positions, orientations, lighting and environmental conditions and resulting image color values recorded in a table. Image color values in photography may be determined by a complex function that varies in response to multiple independent input variables. The data table should characterize typical values that occur for at least the most common and most influential of these variables, for a defined color target, as empirical output values. The camera may use a determination of input variable with such a table to locate the most suitable color reference value to use to compare with a measured color value during field conditions.

During field use of the camera, the transmitter may cooperate with the camera to define key variables such as the color target value, distance from the camera lens, and orientation of one or more color reference surfaces to the camera's line of sight. In some embodiments, only the color target value may be defined. In other embodiments, a position, distance, or orientation sensor may be used to provide information about the relative positions and orientations of the color reference surface and camera, in addition to the color target value. In addition, the color reference article may include a color sensor to measure the color of light impinging on the reference surface, to provide a basis for estimating true color of the reference surface. The transmitter may provide the color target value stored in memory. Other variables may be determined by one or more sensors in communication with either transmitter 108, 110 or the camera 100.

FIG. 2 shows components of a reference article 200 to be placed in a photographed scene and cooperating digital camera 100 for automated white balancing. Camera 100 includes a lens 202 optically coupled to a digital image sensor 204. The image sensor receives a focused optical input from the lens 202 and transforms the input into a pixilated image data output, which may be provided to a processor 206 or multi-processor controller. The processor or controller 206 may be configured to perform typical functions in response to user input, for example providing a display output to a display device 208, for example, an LCD display device, or storing the digital image data in a memory device 210, for example a flash memory chip. Digital image data may be displayed or stored prior to automated white balance correction, after automated white balance correction, or both.

Camera 100 may further comprise a wireless receiver 214 configured to receive a wireless radio or other signal from a transmitter, coupled to the processor or controller 206. The processor or controller 206 may be configured to process a signal from the wireless receiver 214 to obtain white balancing data for use in an automated white balancing method as described more fully herein. In the alternative, or in addition, the processor or controller 206 may simply store obtained data in a storage device 210 for use in white balancing by an external device. Digital image data may also be provided from camera 100 for visible output by an external display device 218 or for producing printed output by a printer 220.

The processor or controller may be configured to perform these and other functions by programming instructions stored in a computer-readable medium 212, for example a flash memory device, magnetic medium, or optical medium. The camera 100 may be configured to load a stored program into a computer memory of the processor or controller when the camera is powered on or initialized. The processor may then execute the program in response to input from a user input device 216. The user input device may comprise one or more devices that are responsive to physical touch or movement to provide an electrical signal to processor 206. The program may also cause the camera to be responsive to input from receiver 214, which may be received from transmitter 222 of reference article 200 placed within the field of view of the camera 100.

The reference article 200 may comprise a visible surface 224 that is tinted, dyed, painted, printed or otherwise colored in a standard known color, for example in a standard white or gray color. A value or values identifying the standard color or colors may be stored in a memory 226 in communication with a processor 228 controlling the transmitter 222. The transmitter, memory and processor may be integrated in a radio- frequency identification device (RFID}, light-emitting diode (LED), or other emitter, which may be battery or wirelessly powered. The reference article may further include a position or orientation sensor 230 in communication with the processor 228. The processor may be configured by program instructions stored in memory 226 to process data from sensor 230 to transmit location or orientation information to camera 100. Sensor 230 may comprise one or more radio, infrared or sound wave receivers or emitters that may be used to in cooperation with corresponding sensors on the camera 100 body to locate the reference article using triangulation, time delay or amplitude modulation. In some embodiments, sensor 230 may comprise an array of two or more sensors in a spaced-apart pattern over the reference article. In addition, or in the alternative, the sensor 230 may comprise a mechanical sensor configured to detect inclination of the reference article with respect to horizontal.

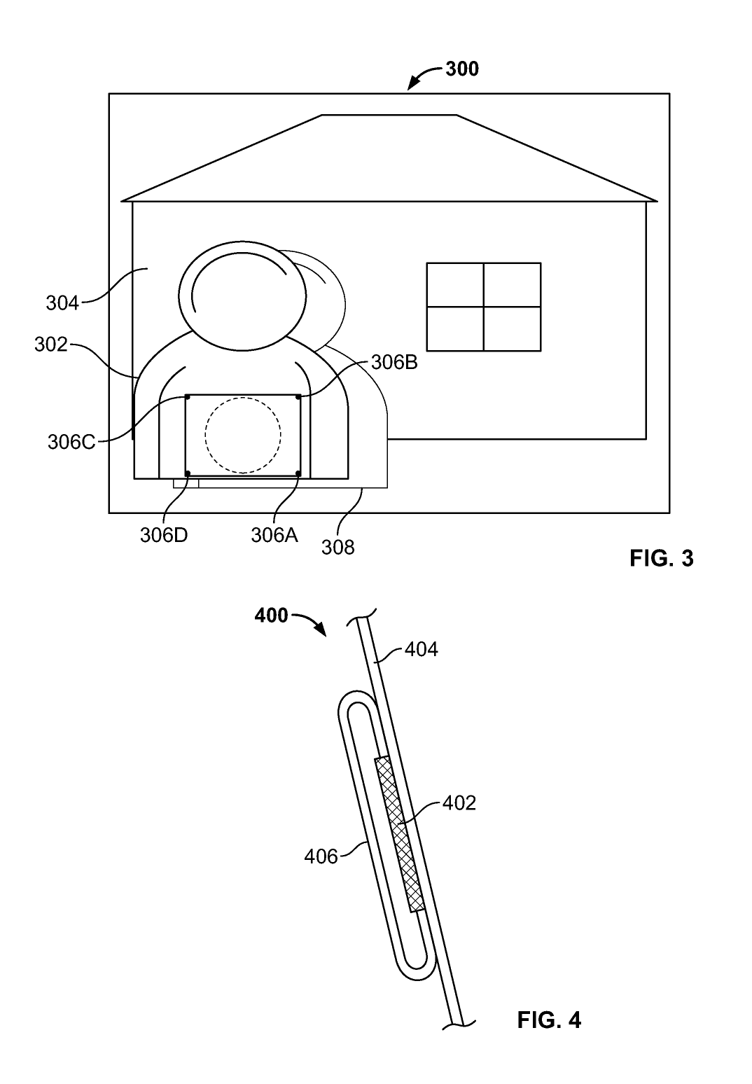

The primary function of the reference article 200 is to present one or more reference colors in the camera's field of view and to transmit information to the camera 100 to enable the camera to automatically determine the color or colors presented. A secondary function of the reference article may be to assist the camera in identifying pixels of the image that represent an image of the color reference surface or surfaces. FIG. 3 illustrates for example a photographic scene 300 comprising a foreground object 302 and a background object 304. An active or passive autofocus system may be used to measure the distance from the camera to the foreground object. In this example, the reference article may comprise the garment worn by the foreground object, a person.

The reference article may include one or more means for indicating the location and/or extent of the color reference to a camera. For example, the garment shown in FIG. 3 may include one or more markers 306A, 3068, 306C and 306D that are detectable by the camera and that indicate a region 308 making up a color reference surface. The markers 306A-D may comprise visible markers that can be detected by image processing. In the alternative, or in addition, the markers may emit or reflect invisible radiation, such as infrared light or radio waves, that can be detected by the camera. As few as one marker may be useful for locating the reference surface. A transmitter 222 for a reference surface may serve as a marker, by indicating the source of a transmission using any suitable wireless locating method, including but not limited to triangulation or attenuation of a directional transmission signal. Similarly, a receiver located on or near the color reference surface may server as a location marker by receiving a location signal from the camera or other transmitter.

The color reference surface may comprise substantially less than all of the pixels making up a scene, for example, less than 5%, less than 10% or less than 20%. The automatic white balancing method may adapt to different locations, orientations and pixel percentages of the reference surface, enabling point and shoot convenience in white balancing and avoiding the need for special test shots.

FIG. 4 shows a cross section of a portion of a reference article 400 comprising a garment. An outer fabric layer 404 is dyed or printed in a standard color. A transmitter/processor device 402 is fixed to the fabric 404. Device 402 may be as described with respect to FIG. 2, comprising at least a transmitter, memory and processor. The device 402 may be protected with an inner lining 406. The device 402 and lining 306 may be removably fixed to the outer fabric layer, using a hook-and-loop fastening system or other suitable fabric fastener, to facilitate removal of the device during laundering.

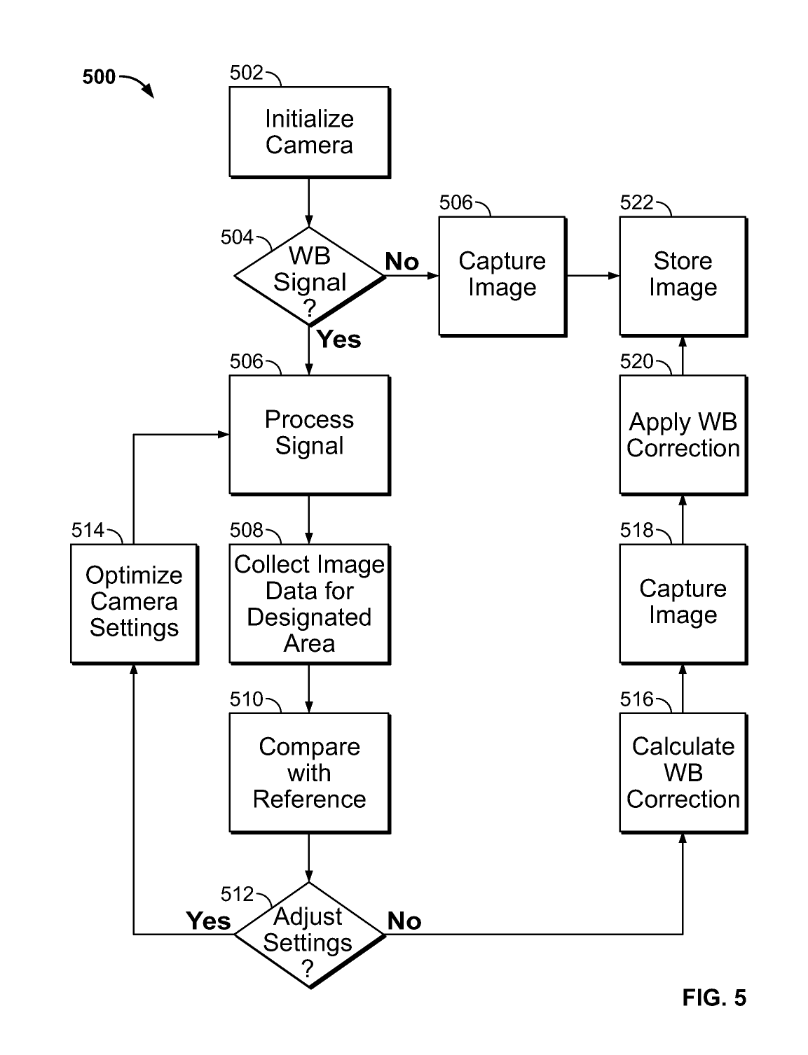

FIG. 5 shows a method 500 for automated white balancing such as may be performed by a camera in cooperation with a reference article as described herein. The camera may be programmed to perform the method using suitable software stored in a camera memory. At 502, the camera may be initialized after being powered on or in response to a “reset” or “initialize” input from a camera input button. During initialization, the camera may perform component checks, drive or set components to a ready state and set control variables to default values recovered from a memory. After initialization, the camera is in a state of readiness for use in capturing a digital photograph.

At 504, the camera scans for a transmitted white balance signal indicating that a reference article as described herein is within camera range. Scanning may include activating a wireless receiver to detect an incoming signal at one or more frequencies, and filtering or otherwise processing received signals to detect a signal from a compatible reference article. Scanning may also include activating a transmitter on the camera to generate a polling signal for an in-range reference article, and receiving a response. If no response is received to the polling signal, the lack of a response may be treated as an indication that no reference article is in range. Until a signal indicating presence of a white-balance reference article is detected, the camera may operate in a normal fashion to capture digital images in a conventional fashion, that is, without automated white balancing. If a compatible white balancing signal is detected 504, the camera may process the signal 506 to extract information relevant to white balancing. Such information may include one or more color reference values and a location of the color reference surface. Location may be determined by detecting markers indicating a location of the color reference article in the photo frame, and estimating the distance to the reference article using an active or passive distance-measuring method such as used for an autofocus function.

Once the location of the reference surface is located, the camera may collect image data for the designated reference area. In some embodiments, image data may be collected by capturing an image 518 wherein the portion of the image functioning as a color reference is defined by associated white balancing information. Information needed for white balancing may be stored in camera memory in association with each digital image. Calculating the white balance correction 516 and applying the white balance correction 520 are then applied after each image is collected. This method may provide an advantage of minimizing pre-shooting activity, permitting more of a “point-and-shoot” experience for the user.

In the alternative, or in addition, the camera may collect image data for the color reference surface 508 prior to image capture 518, as part of pre-imaging activity. In these embodiments, the color hue of the imaged reference surface may be compared with the color standard hues in a camera memory 510 to calculate an appropriate white balance correction. In addition, when functioning in an automatic mode, the camera may determine 512 whether any camera settings, for example, f-stop, ISA setting, or flash setting, should be adjusted under lighting conditions that may be inferred from comparing the image of the color reference surface to a standard color table in computer memory. Optionally, the camera may automatically adjust camera settings 514 to obtain a truer-color image under the inferred lighting conditions. The process of collecting the reference image data 508 and comparing to a stored standard 510 may then be repeated at the adjusted settings.

If the camera settings are already optimized, or if it is desired to bypass adjusting the camera settings to save time, the camera settings may remain unadjusted. The camera may then calculate an appropriate white balance correction based on a comparison of the imaged color reference to the color standard. The image may be captured 518 in a conventional fashion and stored in a camera memory 522 for later output as an electronic or printed image. The image may be stored with metadata for later white balance correction. In the alternative, or in addition, the camera may perform the selected white balance correction 520 prior to storing image data 522 in camera memory.

Having thus described a preferred embodiment of automated white balancing in digital photography, it should be apparent to those skilled in the art that certain advantages of the within methods, apparatus and systems have been achieved. It should also be appreciated that various modifications, adaptations, and alternative embodiments thereof may be made without departing from the scope and spirit of the present technology. Accordingly, an enabling disclosure has been made of subject matter defined by the appended claims.

1. An article of clothing comprising:
at least one area of a known color;
an optical pattern encoded on the article of clothing, the optical pattern encoding data identifying color reference information for the at least one area of known color.

2. The article of clothing of claim 1, wherein the optical pattern is located within the at least one area of a known color.

3. The article of claim 1, wherein the optical pattern is located outside of the at least one area of a known color.

4. The article of claim 1, wherein the optical pattern is a watermark.

5. The article of claim 1, wherein the optical pattern is an optical code.

6. The article of claim 1, wherein the color reference information comprises a position and size of the at least one area of known color, and the color value.

7. The article of claim 6, wherein the color reference information further comprises an orientation of the at least one area of known color.

8. An article of clothing comprising:
a plurality of areas of known colors;
an optical pattern encoded on the article of clothing, the optical pattern encoding data identifying color reference information for at least one of the plurality of areas of known colors.

9. The article of claim 8, wherein the optical pattern for at least one of the plurality of areas of known colors is located within the at least one of the plurality of areas of known colors.

10. The article of claim 8, wherein the optical pattern for at least one of the plurality of areas of known color is not located within the area corresponding to the known color.

11. The article of claim 8, wherein the optical pattern is a watermark.

12. The article of claim 8, wherein the optical pattern is an optical code.

13. The article of claim 8, wherein the color reference information comprises a position and size of the at least one of the plurality of areas of known color, and an identifier by which a digital camera can locate the size and color value of the at least one area of known color.

14. The article of claim 13, wherein the color reference information further comprises an orientation of the at least one area of known color of the plurality of areas of known color.

15. An article of clothing comprising:
a plurality of areas of known colors:
an optical pattern encoded on the article of clothing, the optical pattern encoding data identifying color reference information for at least two of the plurality of areas of know colors.

16. The article of claim 15, wherein the optical pattern for at least one of the plurality of areas of known colors is located within the at least one of the plurality of areas of known colors.

17. The article of claim 15, wherein the optical pattern for at least one of the plurality of areas of known colors is not located within the area corresponding to the known color.

18. The article of claim 15, wherein the optical pattern is a watermark.

19. The article of claim 15, wherein the optical pattern is an optical code.

20. The article of claim 15, wherein the color reference information comprises a position and size of the at least one area of known color, and the color value.
